(19) United States
(12) Patent Application Publication
(10) Pub. No.: US 2015/0255051 A1
(43) Pub. Date: Sep. 10, 2015

(54) Drumstick Leverage and Comfort Attachment

(71) Applicant: Robert T. Sundby, Rapid City, SD (US)

(72) Inventor: Robert T. Sundby, Rapid City, SD (US)

(21) Appl. No.: 14/200,282

(22) Filed: Mar. 7, 2014

(51) Int. Cl. G10D 13/00

(52) U.S. Cl. CPC G10D 13/003

(57) ABSTRACT

The embodiments described include a type of drumstick and/or drumstick attachment allowing for greater and enhanced control, comfort, leverage and power by the user through the use of a soft contouring compound that includes a gel, gel-like, rubber, plastic or other like material which allows the fingers and hands of the musician or holder, compression and also increased contact resulting in more comfort, less fatigue and more responsiveness.

### BACKGROUND

The standard method for musicians using drumsticks is to grip the stick(s) as it exists, with no attachments or modifications to the stick(s). The majority of drummers use what is called “matched grip” where each stick is held the same with the left and right hand. Another method of holding a stick is called “traditional” grip where one hand (left hand for a right handed drummer) is turned up approximately 90 degrees with the stick resting on the c-shaped part of the hand.

Occasionally a musician/drummer (i.e. user) who performs for a period of time will develop blisters from the friction and heat that is created against the skin Sometimes tape around the contacted area of the index finger assists with this problem.

Another issue that can result from extended performance or contact with the drumstick(s) is the potential loss of grip or adhesion due primarily to sweat. Once again tape has been used by some to be wrapped around the drumstick, in an attempt to alleviate this problem. The problem has also been somewhat mitigated with the use of a paint coating which is less slippery than the standard wood surface of a drumstick.

Drumsticks come in many different lengths and diameters. There are generally wood tip sticks and nylon tip sticks. Wood drumsticks account for a majority of the sticks used although there are exceptions with plastic or alloy versions.

### SUMMARY

The embodiments described below include a type of drumstick and/or drumstick attachment allowing for greater and enhanced control, comfort, leverage and power by the user through the use of a soft contouring compound that includes a gel, gel-like, rubber, plastic or other similar material which allows the fingers and hand(s) of the musician or holder, compression and also increased contact resulting in more comfort, less fatigue and improved responsiveness.

The musician enjoys a fit and compression that is created by the device via a soft-surfaced contoured and custom shaped compound which is made of a dynamic material such as gel or gel-like substance, air, rubber, plastic or other like material. The comfortable compression occurs against the fingers and hand(s) of the musician.

The device creates the ability of the user to maintain consistent and steady contact between the fingers/hands and the (traditional) drumstick. The result of the above is more comfort, less fatigue and improved responsiveness.

The compression also creates stored energy that is released upon the user playing the instrument. Stored energy, like leverage below, creates the ability of the musician to have increased musicality, attack or volume upon the instrument.

The design allows for increased leverage upon the traditional stick design. The leverage results from the increased diameter of the device, relative to the traditional drumstick, along with the unique stable design which also aids in increased leverage. The increased leverage, like stored energy above, allows for increased musicality, volume and attack of the instrument.

### BRIEF DESCRIPTION OF THE DRAWINGS

The apparatus and/or method may be better understood with reference to the following drawings and description. Non-limiting and non-exhaustive embodiments are described with reference to the following drawings. The components in the drawings are not necessarily to scale, emphasis instead being placed upon illustrating the principles of the invention.

FIG. 1 is a side view of one embodiment of a drumstick.

FIG. 2 is a front view of one embodiment of a drumstick.

FIG. 3 is an alternate side view of one embodiment of a drumstick.

### DETAILED DESCRIPTION

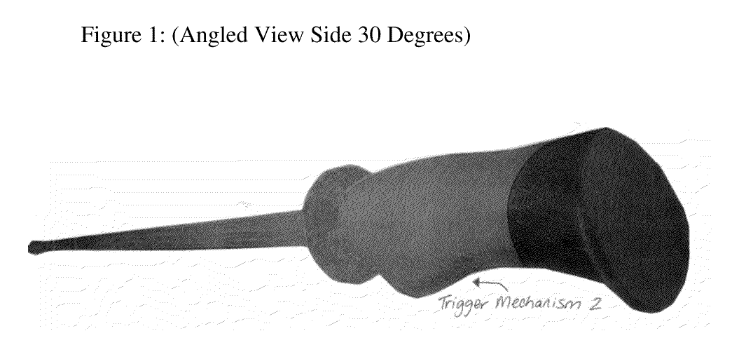

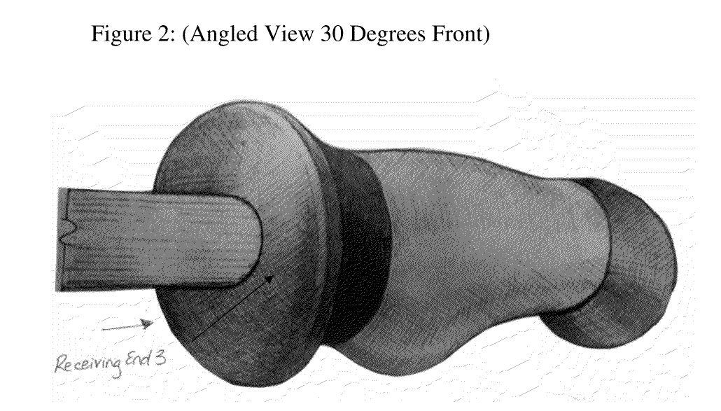

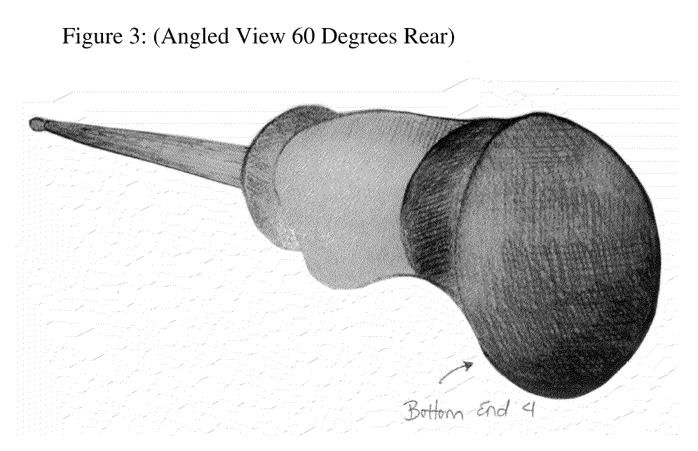

Described herein and illustrated in FIGS. 1-3 is an embodiment of a drumstick attachment. In one embodiment, the drumstick attachment may be a part of a traditional drumstick. In another embodiment, the drumstick attachment may be removable to/from the drumstick. The shape and design of the drumstick illustrated in the Figures and described below is merely exemplary. Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

Advantages of the invention compared to prior art include:

Comfort to the User—Friction and blisters upon user's skin, are eliminated or reduced.

Increased Responsiveness & Control—More surface contact with user's fingers/hands creates this effect. As does the device's design for stable finger placement.

Increased Leverage, Power & Energy—Definition of leverage: “The exertion of force by means of a lever or an object used in the manner of a lever”. In the case of the described embodiments, leverage allows for increased force to be applied to the musical instrument. Definition of force: Strength or energy as an attribute of physical action or movement.

Increased Musicality: Definition of musicality: Tastefulness and accomplishment in music. The aforementioned results and characteristics of the invention allow for greater musicality by the user or musician.

In particular, the comfort and increased control/power/energy allow for the drummer to more effectively and efficiently utilize the drumstick. For example, the increased leverage provided by the embodiments described herein allow the drummer to utilize an increased force from the drumstick to the drum which results in different or improved sounds from the drum. The improved control provided by the embodiments allows the drummer to be able to more accurately create the desired sound.

Features of the embodiments are described below. FIGS. 1-3 illustrate one or more embodiments of the drumstick attachment including the following features.

SOFT-SURFACED COUNTOURED AND CUSTOM SHAPED COMPOUND. The contours illustrated in the Figures are designed to more accurately fit the drummer's hand. In addition, the surface of the attachment is a softer surface. For example, the softer surface may be a custom shaped compound which is made of a dynamic material such as gel or gel-like substance, air, rubber, plastic or other like material.

A CYLINDRICAL STRUCTURE allowing for the housing of the soft contouring compound. This structure is generally parallel to the drum stick and of a larger diameter than the drumstick. This structure couples with the soft-surfaced and contoured compound to allow for more surface area contact between fingers and the attachment, customized compression, contouring, or molding to the user's fingers and hand(s), and more stored energy, responsiveness and leverage which all increase desired musicality of the user. This cylindrical structure houses the soft contouring compound. This element of the embodiment allows for further leverage due to its larger diameter than the drumstick itself.

TRIGGER STRUCTURE 2 or ANTI-SLIP FIN for keeping index finger and other fingers/hand in a stable comfortable are of the invention. This element and structure adds to the effectiveness of the features above by creating a stable finger(s) and hand platform, hinge point or fulcrum point resulting in increased speed and control by the musician or user. In contrast to perpendicularly-oriented cylindrical structure below which minimizes or eliminates forward slippage of the hand/fingers, the trigger structure minimizes or eliminates the hand/fingers from sliding backward on the stick.

RECEIVING END 3 to house the drum stick. In the embodiment where the attachment is removable, the attachment includes a receiving area for the drumstick. This structure is located generally parallel to both the stick and the cylindrical structure above.

PERPENDICULARLY ORIENTED CYLINDRICAL STRUCTURE also helps maintain a stable finger(s) and hand platform along with hinge point or fulcrum point allowing for increased speed and control by the musician or user. This structure may assist to prevent forward slippage of the finger(s) and/or hand(s).

One alternate embodiment is the creation of the invention manufactured in less separate elements, such as a single piece of plastic or wood. Or the embodiment may include two or more manufactured pieces.

Another embodiment is the use of an attached ring instead of the trigger finger structure shown, the ring may serve to prevent slippage of the index and other fingers upon the stick. The ring embodiment may also serve to aid the user in twirling of the stick(s) which are a common technique of musicians with drumsticks.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural, logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

1. A drumstick attachment comprising a soft contouring compound comprising:
a cylindrical structure with an increasing diameter near a bottom end of the attachment;
a trigger mechanism as a contour in the compound near a top end of the attachment; and
a drumstick receiving portion from which a drumstick extends at the top end of the attachment.

2. The drumstick attachment of claim 1 wherein the soft contouring compound comprises one of a gel, gel-like, rubber, plastic or similar material.

3. The drumstick attachment of claim 1 wherein the trigger mechanism receives an index finger.

4. The drumstick attachment of claim 1 wherein the drumstick receiving portion is opposite the bottom end.

5. The drumstick attachment of claim 1 wherein the drumstick receiving portion comprises a concave female structure that receives the drumstick which is removable from the attachment.

6. The drumstick attachment of claim 1 wherein the increasing diameter allows for a customized compression, contouring, or molding to a user's fingers.

7. The drumstick attachment of claim 1 wherein the increasing diameter results in the cylindrical structure having its greatest diameter at the bottom end.

8. The drumstick attachment of claim 1 wherein a diameter of the cylindrical structure is uniform from the top end to below the trigger mechanism and the increasing diameter begins below the trigger mechanism through the bottom end.

9. The drumstick attachment of claim 1 wherein the drumstick attachment and drumstick are combined as a single product.

10. The drumstick attachment of claim 1 wherein the soft contouring compound comprises a contouring substance such as gel, foam, air, rubber or another substance on or near the area where a user grips the drumstick.

11. The drumstick attachment of claim 1 wherein the cylindrical structure comprises a cylindrical barrier perpendicular to axis of drumstick, preventing forward slippage of a user's fingers.

12. The drumstick attachment of claim 1 wherein the trigger mechanism comprises a convex attachment.

13. The drumstick attachment of claim 12 wherein the convex attachment comprises a ring.

14. A drumstick attachment comprising:
a cylindrical structure made from a soft contouring compound that has an increasing diameter near a bottom end of the attachment;
a ring around the cylindrical structure near a top end of the attachment; and
a drumstick receiving portion from which a drumstick extends at the top end of the attachment.

15. The drumstick attachment of claim 14 wherein the ring is removable from the cylindrical structure.

16. The drumstick attachment of claim 14 wherein the ring receives an index finger.

17. A drumstick attachment made from a soft compound comprising:
a cylindrical structure with an increasing diameter near a bottom end of the attachment;
an anti-slip fin as a contour in the soft compound near a top end of the attachment, wherein the anti-slip fin is a larger diameter than the cylindrical structure adjacent the anti-slip fin, further wherein the bottom end of the attachment is at a larger diameter than the anti-slip fin; and
a drumstick portion from which a drumstick extends at the top end of the attachment.

18. The drumstick attachment of claim 17 wherein the soft compound comprises a contouring substance such as gel, foam, air, rubber or another substance on or near the area where a user grips the drumstick.

19. The drumstick attachment of claim 17 wherein the anti-slip fin is part of the cylindrical structure.

20. The drumstick attachment of claim 17 wherein the drumstick portion comprises a female structure that receives the drumstick which is removable from the drumstick attachment.
